(19) United States
(12) Patent Application Publication
(10) Pub. No.: US 2018/0116257 A1
(43) Pub. Date: May 3, 2018

(54) SYSTEMS AND METHODS FOR REDUCING BACTERIA FOR ITEMS AND EXTENDING SHELF LIFE WHEN APPLIED TO FOOD SURFACES

(71) Applicants: Mareya Shawki Ibrahim, Aliso Viejo, CA (US); Shawki Amin Ibrahim, Aliso Viejo, CA (US)

(72) Inventors: Mareya Shawki Ibrahim, Aliso Viejo, CA (US); Shawki Amin Ibrahim, Aliso Viejo, CA (US)

(21) Appl. No.: 15/706,410

(22) Filed: Sep. 15, 2017

Related U.S. Application Data
(60) Provisional application No. 62/394,953, filed on Sep. 15, 2016.

(51) Int. Cl. A23L 3/3508; A23B 7/154; A23B 7/157; A23L 3/3472; A23B 4/20; A23B 4/24

(52) U.S. Cl. CPC A23L 3/3508; A23B 7/154; A23B 4/24; A23L 3/3472; A23B 4/20; A23B 7/157

(57) ABSTRACT

Systems, devices, and methods for substantially reducing surface contaminants of a food and inhibiting yeast, mold and bacteria growth in a food, beverage or food grade cosmetic preparation comprising a substantially transparent and odorless solution made from a plurality of substantially organic compounds selected from: citric acid, sodium citrate, vegetable glycerin sea salt, potassium sorbate, decyl glucoside, Sodium Lauryl Sulfate, calcium ascorbate, grapefruit seed extract, Quillaja Saponin, Lauryl Glucoside, calcium carbonate, ascorbic acid, sodium percarbonate and sodium bisulfate, and an applicator for applying the solution to the food substance.

### CROSS-REFERENCE TO RELATED APPLICATIONS

This application claims priority to U.S. Provisional Application No. 62/394,953 filed Sep. 15, 2016, titled “SYSTEMS AND METHODS FOR REDUCING BACTERIA ON FOOD SURFACES WHILE EXTENDING SHELF LIFE,” which is hereby incorporated by reference in its entirety.

This application is related to U.S. patent application Ser. No. 13/544,139, filed 9 Jul. 2012, which is a continuation of PCT Application No. PCT/US2012/023895, filed on 4 Feb. 2012, which is a continuation-in-part of U.S. patent application Ser. No. 13/020,874, filed 4 Feb. 2011, which is based on U.S. Provisional Application No. 61/381,074, filed 9 Sep. 2010, the contents and disclosure of which are fully incorporated herein by reference.

### BACKGROUND

The invention relates to a system of substantially reducing bacteria, yeast, mold, food borne illness causing organisms and other contaminants in food and on food surfaces, primarily fresh produce, seafood, poultry, beverages, food preparations and food based cosmetic applications, while simultaneously extending shelf life, reducing spoilage, bacteria and mold growth by applying an antimicrobial, antioxidant solution made from all natural compounds to the food surface, the ingredient deck of a prepared food or a food-grade cosmetic or oral care product. The system is applied via a liquid solution or a biodegradable wipe treated with the solution. The wipes do not require rinsing. The system may also be applied via solid form such as a powder or tablet. The powder or tablet may be made with effervescent ingredients and may dissolve readily in water or other liquid, including but not limited to the natural moisture of the food substance. The powder may be mixed directly into food as a natural additive if there is sufficient moisture content to distribute the powder effectively throughout. The powder may also be reconstituted and applied as a liquid soak, dip or spray to the surface of foods as a sanitizer or incorporated into a recipe to extend shelf life.

Food borne illnesses are an increasing concern in homes across the country. These illnesses are present in part because the foods being sold at grocery stores are grown in organic soil and manure and treated with pesticides and chemicals, then are covered with non-water soluble wax, which can make foods dangerous to consumers upon ingestion. Additionally, these illnesses are sometimes spread when food is not preserved, washed or stored properly, causing the microorganisms, bacteria, dirt, or other particles naturally found in or on the food to be ingested. While consumers are generally aware of the risks of food borne illnesses, they nonetheless fail or are unable to effectively remove the chemicals and bacteria that is the cause.

Waste of fresh foods is one of the leading causes of methane emissions in landfills. According to the U.S. Department of Agriculture, Fresh fruits and vegetables accounted for nearly 20 percent of consumer and foodservice losses. Methane gas from fresh fruit and vegetables is considered 21 times more harmful than carbon dioxide. The environmental impact of this waste affects the global economy.

Most consumers simply wash foods with plain water, however this method generally fails to effectively bring harmful chemicals and bacteria to a safe level for human consumption. Furthermore, water is generally ineffective at removing protective wax from fruits and/or vegetables. Other food wash solutions with chemical compounds are also available. These chemicals are often harsh smelling, turbid, and leave a residue that affects the taste of the food or unsafe if ingested. Solutions are available that are effective in reducing bacteria and pesticide content, and that do not leave a chemical residue; however these washes are generally a disinviting color and are accompanied by a bad taste, both of which discourage usage. Often, their efficacy in food service or manufacturing/processing is limited and may be dangerous. Some are made of chemicals potentially linked to cancer, hyperactivity and other harmful side effects. Some do not allow manufacturers to reach the shelf life they are seeking, while controlling microorganism growth adequately.

As food surface sanitizing product, there is a very strong demand in the organic produce industry to identify safe, effective alternatives to the widespread use of chlorine as a microbial control. Likewise, the food industry is actively seeking all natural, effective products for their customers who are asking for natural, non-allergenic treatment of food.

Currently there are no standardized systems or methods for cleaning produce and many other foods. As such, unclean food may cause people to become sick when they eat the food. The FDA has even noted that five out of the ten riskiest foods for causing illnesses are produce items, while leafy greens are the most likely.

A powerful, safe, concentrated, quick and evenly dissolving powder and tablet solution eliminates the need to transport water, which is costly and often inefficient, while adding additional stability and shelf life. Additionally, the end user can use the products in an infinite number of varying concentrations to meet their specific needs.

It is therefore desirable for an organic food wash solution that is substantially odorless, colorless, tasteless and safe, and which can be easily produced at low cost and effort, and which may be used on fresh produce, seafood, poultry, legumes, nuts and other raw ingredients prone to microorganisms, yeast or mold.

### SUMMARY

Provided herein are embodiments of systems and methods for providing an all-natural solution that is easily produced without resort to dangerous or artificial chemicals or heat, and which can remove dirt, pesticides, chemicals and odors, and which can reduce oxidation and spoilage of fresh food, without leaving a residual chemical taste or smell.

Other features and advantages of the present invention will become apparent from the following more detailed description, taken in conjunction with the accompanying drawings, which illustrate, by way of example, the principles of the presently described apparatus and method of its use.

The configuration of these systems is described in detail by way of various embodiments which are only examples and can provide many benefits including worker safety, fewer or no side effects for end consumers, enhanced product shelf life, improved food flavor, reduced shrinkage, cost savings, improved bacteria reduction, convenience, reduced odors, improved costs and ease of use, to name a few.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A shows an example embodiment flowchart diagram detailing an order of steps for organic compounds to be dissolved.

FIG. 1B shows an example embodiment flowchart diagram detailing an order of steps for organic compounds to be dissolved.

FIG. 1C shows an example embodiment diagram showing that a solution comprises the combination of a solute and a solvent.

FIG. 2 shows an example embodiment flowchart diagram detailing steps for cleaning using a cleansing packet of formula.

FIGS. 3A-3B show an example embodiment single-serving cleansing packet of formula.

FIG. 4 shows an example embodiment packaging for a plurality of single-serving cleansing packets of formula.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

The above described drawing figures illustrate the described solution and its method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present apparatus and its method of use.

Food-grade Sodium Lauryl Sulfate (SLS) has been found to be very effective in killing pathogens using laboratory tests. SLS is widely available, convenient and cost efficient in various formulas and formulations, such as those detailed herein. Another surfactant, Lauryl Glucoside, has also been found to be effective at pathogen killing and provides similar advantages and is also described herein.

In some embodiments, systems and methods described herein can extend shelf life by nearly 200% over existing systems and methods. For produce, this can help to extend shelf life up to five times longer, while inhibiting yeast, bacteria, and mold growth. Further, in some embodiments, systems and methods described herein can reduce or remove wax and other residue up to 99.9% more effectively than water alone and can be more effective than using chlorine and peracetic acid. As such, they can be used to remove up to 99.9% of bacteria, including and not limited to: Salmonella, E.coli (both generic and O157-H7), Listeria, Coliform and others. An additional advantage is that these concepts can remove up to 99.8% of pesticide residue. Some embodiments include wipes that are biodegradable. Various concentrations can be used and can be applied to food or other surfaces by dipping, spraying, soaking, wiping and others. Various embodiments can be more effective than one or both of chlorine and peracetic acid, in addition to other cleaners.

Features described herein can include synergistic blending of antioxidant and antimicrobial ingredients to remove contaminants and preserve the color and freshness of foods, such as: funghi, berries, greens, citrus, root vegetables, herbs and others. In particular they can be used to result in colorless, tasteless and odorless finishes on the surfaces of fruit and vegetables which help to avoid transferring contaminants through food skins. Bacteria reduction mechanisms used herein can cause cell, electro/potential disruption. Additionally, the systems and methods described herein can help to control the pH environment on the surface of produce can provide inhibiting characteristics on the growth of mold, which breaks down and deteriorates fresh fruits and vegetables.

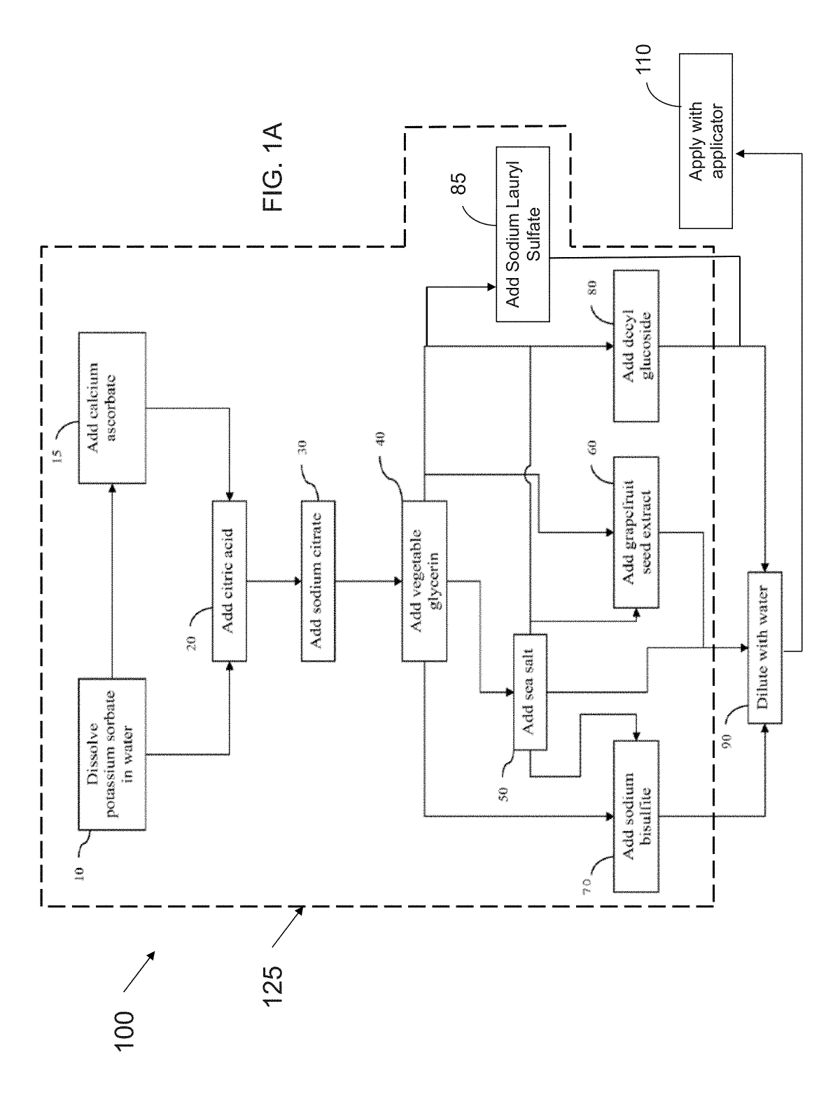

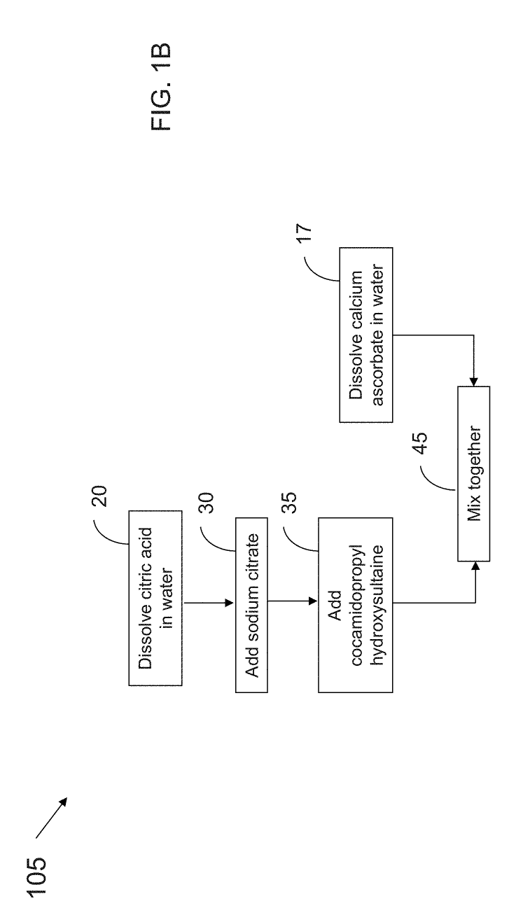

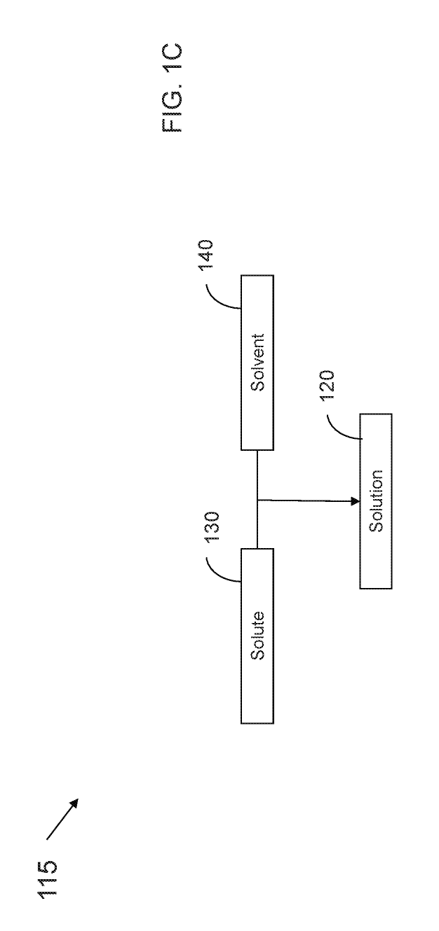

FIG. 1 shows an example embodiment flowchart diagram 100 detailing an order of steps for organic compounds to be dissolved. As shown in the example embodiment, a system for substantially reducing surface bacteria of a food substance can include the creation of a solution or combination of ingredients 125 that has a plurality of substantively organic compounds, which are then dissolved or otherwise diluted in water in a step 90, and can then be applied using an applicator in a step 110 to a surface of an item or food substance. The solution can be substantially transparent, tasteless and odorless. The applicator may be, in various embodiments, a wipe, towelette, sponge, spray bottle, dropper, brush, or any other type of applicator operable to apply the solution to a surface of the item or food substance.

In an example embodiment, the solution created according to flowchart 100 preferably consists of a plurality of all natural compounds. A first compound can be operable to substantially kill bacteria, remove wax, and inhibit browning, and is preferably citric acid. A second compound can be operable to substantially increase bacteria kill efficacy and prolong shelf life, and is preferably sodium citrate. A third compound can be operable to substantially increase bacteria kill efficacy and prolong shelf life, and is preferably sea salt. A fourth compound is operable to facilitate adherence of the solution to a food surface and is preferably vegetable glycerin. A fifth compound can be operable to preserve a substantially transparent color in the solution, and to substantially prevent mold and bacteria growth, and is preferably potassium sorbate. A sixth compound can be operable to facilitate the removal of mud, fat soluble contaminants, pesticide residue and the like, and is preferably Decyl Glucoside, Sodium Lauryl Sulfate, Lauryl Glucoside or Cocamidopropyl Hydroxysultaine. A seventh compound can be operable to substantially inhibit browning, and is preferably calcium ascorbate or the two components which create the compound, calcium carbonate and ascorbic acid.

In some embodiments, the solution preferably consists of a plurality of substantively organic compounds selected from: citric acid, sodium citrate, vegetable glycerin, sea salt, Decyl Glucoside, Lauryl Glucoside, Sodium Lauryl Sulfate, Cocamidopropyl Hydroxysultaine, calcium ascorbate, potassium sorbate, grapefruit seed extract, and sodium bisulfite. The compounds are generally dissolved in distilled, deionized, or triple filtered water.

In some embodiment, the solution comprises approximately: 2% to 4% citric acid, 2% to 4% sodium citrate, 0.2% to 1.4% vegetable glycerin, 0.2% to 0.4% potassium sorbate; 0% to 0.8% decyl glucoside, 0% to 0.2% calcium ascorbate, 0% to 0.2% grapefruit seed extract, 0% to 0.1% sodium bisulfate, and 0.2% to 2% to 4% sea salt. The compounds are preferably dissolved in deionized or triple filtered water to produce the solution.

In at least one embodiment, a solute can include about: 450-480 g of citric acid, 210-240 g of sodium citrate, 210-240 g of sodium lauryl sulfate, 18-22 g of ascorbic acid, 7-15 g of calcium carbonate, and 15 g of vegetable glycerin, by weight. It should be understood that in various embodiments the ratios of the compounds in various solutes may remain constant, even while specific amounts may vary.

In some embodiments, the solution can include about: 93.4% water, 2% citric acid, 2% sodium citrate, 2% sea salt, 0.2% vegetable glycerin and 0.4% calcium ascorbate. In the system of the present embodiment, the solution is preferably applied to seafood and poultry via a spray applicator. Alternatively, the solution may be applied to fruit and vegetables via towelette applicators.

In alternative embodiments, the solution can include about: 93.1% water, 2% citric acid, 2% sodium citrate, 2% sea salt, 0.2% vegetable glycerin, 0.2% potassium sorbate, 0.4% decyl glucoside, and 0.1% calcium ascorbate. In the system of the present embodiment, the solution is preferably applied to fruits and vegetables via a spray applicator.

In alternative embodiments, the solution can include about: 87.4% water, 4% citric acid, 4% sodium citrate, 4% sea salt, 0.4% vegetable glycerin and 0.2% potassium sorbate.

In other embodiments, the solution can include about: 86.2% water, 4% citric acid, 4% sodium citrate, 4% sea salt, 0.4% vegetable glycerin, 0.4% potassium sorbate, 0.8% decyl glucoside, and 0.2% calcium ascorbate.

In alternative embodiments, the solution can include about: 95.2% water, 2% citric acid, 2% sodium citrate, 0.2% sea salt, 0.2% vegetable glycerin, and 0.2% calcium ascorbate.

In alternative embodiments, the solution can include about: 95% distilled water, 2% citric acid, 2% sodium citrate, 0.2% sea salt, 0.2% vegetable glycerin, 0.2% potassium sorbate, 0.2% decyl glucoside, and 0.2% calcium ascorbate.

In alternative embodiments, the solution can include about: 95.2% distilled water, 2% citric acid, 2% sodium citrate, 0.2% grapefruit seed extract, 0.2% vegetable glycerin, 0.2% potassium sorbate, and 0.2% calcium ascorbate.

In alternative embodiments, the solution can include about: 95.2% distilled water, 2% citric acid, 2% sodium citrate, 0.2% sodium bisulfite, 0.2% vegetable glycerin, 0.2% potassium sorbate, and 0.2% calcium ascorbate.

In at least one embodiment, the solute comprises, by weight: 450-480 g of citric acid, 210-240 g of sodium citrate, 210-240 g of lauryl glucoside, 18-22 g of ascorbic acid, 7-15 g of calcium carbonate, and 15 g of vegetable glycerin. It should be understood that in various embodiments the ratios of the compounds in various solutes may remain constant, even while specific amounts may vary.

In various embodiments, the combination of the all-natural compounds can be performed according to the methods described below and preferably results in the solution being substantially transparent, tasteless, and odorless.

Various advantages can be provided by the present systems and methods when they are accomplished according to the order that the compounds are dissolved in the solution, in a variety of steps. As mentioned previously, FIG. 1 illustrates an example embodiment flowchart diagram 100 of an order of dissolution of compounds or ingredients that can be applied to items and food surfaces. In each of the below steps, the compounds being added according to the step are preferably dissolved until a clear solution results. Furthermore, the dissolution of the organic compounds can be accomplished at or near room temperature.

In a first step 10, a first organic compound, potassium sorbate, can be dissolved in an initial portion of water until a clear solution results. After a clear solution results, citric acid can be dissolved in a step 20 in the solution until clear. In some embodiments, an intermediate step is conducted between the dissolution of potassium sorbate and the dissolution of the citric acid. The intermediate step can be a step 15 of dissolving the calcium ascorbate in the potassium sorbate solution until the solution is again clear.

Next, sodium citrate can be dissolved in the solution in step 30 until the solution is clear. Then, vegetable glycerin can be added in step 40 to the solution and dissolved until clear. Subsequently, at least one step of: adding sea salt 50, adding grapefruit seed extract 60, adding sodium bisulfite 70, and adding decyl glucoside 80 to the solution can be performed and dissolved until clear.

In some embodiments, sea salt is added to the solution and dissolved until clear in step 50, and then at least one step of: adding sodium bisulfite 70, decyl glucoside 80, and adding Sodium Lauryl Sulfate (SLS) 85 can be added to the solution and dissolved until clear.

In some embodiments, exactly one of: the sea salt in step 50, the sodium bisulfite in step 70, the decyl glucoside in step 80, the Sodium Lauryl Sulfate in step 85, and the grapefruit seed extract in step 60 can be added to the solution and dissolved until clear.

In some embodiments, the decyl glucoside may be replaced with Lauryl glucoside, cocamidopropyl Hydroxysultaine or Sodium Lauryl Sulfate.

Finally, in step 90 an additional or remaining portion of water can be added to the solution.

In an alternative embodiment, the ingredients can comprise a concentrated solution consisting of: 58.5% water, 20% citric acid, 10% sodium citrate, 10% cocamidopropyl hydroxysultaine, 1% glycerin, and 0.5% calcium ascorbate.

FIG. 1B shows an example embodiment flowchart diagram 105 detailing an order of steps for organic compounds to be dissolved to form a solution. As shown in the example embodiment, a solution can be prepared according the following steps: First, citric acid can be dissolved in substantially all of the water and mixed until a clear solution is produced in step 20. Second, sodium citrate can be added to the solution and mixed until the solution is again clear in step 30. Third, cocamidopropyl hydroxysultaine can be added to the solution and mixed until the solution is again clear and forms a primary solution in step 35. Finally, calcium ascorbate can be dissolved separately in another or remaining portion of the water in step 17 to form an ancillary solution and the ancillary solution can be mixed with the clear, primary solution in step 45.

FIG. 1C shows an example embodiment diagram 115 showing that a solution 120 comprises the combination of a solute 130, here a plurality of substantively organic compounds, and a solvent 140.

In an example embodiment, a solute 130 can be preferably a substantially homogeneous powder comprising a plurality of all natural compounds. The solute 130 may be in the form of a powder or a tablet. A first compound can be operable to substantially kill bacteria, remove wax, and inhibit browning, and is preferably citric acid. A second compound is operable to substantially increase bacteria kill efficacy and prolong shelf life, and is preferably sodium citrate. A third compound can be operable to substantially increase bacteria kill efficacy and prolong shelf life, and is preferably sea salt. A fourth compound can be operable to facilitate adherence of the solution to a food surface and is preferably vegetable glycerin. A fifth compound can be operable as an oxidizer to enhance antimicrobial efficacy, and is preferably sodium percarbonate. A sixth compound can be an antioxidant operable to enhance shelf life, and is preferably ascorbic acid. A seventh compound can be non-allergenic surfactant operable to lift non-water-soluble agents like wax, pesticides and soils, contains antimicrobial properties, and is preferably sodium lauryl sulfate. An eighth compound can be a mineral operable to enhance efficacy of the sixth compound, and is preferably calcium carbonate. One or more of these compounds may be combined to form the solute 130.

In at least one embodiment, the solute 130 comprises, by weight: 2.4 g of citric acid, 1.2 g of sodium citrate, 1.2 g of sodium lauryl sulfate, 0.090 g of ascorbic acid, 0.035 g of calcium carbonate, and 0.075 g of vegetable glycerin. It should be understood that the ratios of the compounds may remain constant while specific amounts may vary.

In at least one embodiment, the solute 130 comprises, by weight: 2.4 g of citric acid, 1.2 g of sodium citrate, 1.2 g of sodium lauryl sulfate, 0.090 g of ascorbic acid, 0.035 g of calcium carbonate, and 0.075 g of vegetable glycerin. It should be understood that the ratios of the compounds may remain constant while specific amounts may vary.

In at least one embodiment, the solute 130 comprises, by weight: 1.2 g of citric acid, 1.2 g of sodium citrate, 1.2 g of sodium percarbonate, 1.2 g of sodium lauryl sulfate, 0.090 g of ascorbic acid, 0.035 g of calcium carbonate, and 0.075 g of vegetable glycerin. It should be understood that the ratios of the compounds may remain constant while specific amounts may vary.

In at least one embodiment, the solute 130 comprises, by weight: 480 g of citric acid, 240 g of sodium citrate, 240 g of sodium lauryl sulfate, 18 g of ascorbic acid, 7 g of calcium carbonate, and 15 g of vegetable glycerin. It should be understood that the ratios of the compounds may remain constant while specific amounts may vary.

In at least one embodiment, the solute 130 comprises, by weight: 480 g of citric acid, 240 g of sodium citrate, 240 g of sea salt, 18 g of ascorbic acid, 7 g of calcium carbonate, and 15 g of vegetable glycerin. It should be understood that the ratios of the compounds may remain constant while specific amounts may vary.

In at least one embodiment, the solute 130 comprises, by weight: 480 g of citric acid, 240 g of sodium citrate, 240 g of sea salt, 18 g of ascorbic acid, 7 g of calcium carbonate, and 15 g of vegetable glycerin. It should be understood that the ratios of the compounds may remain constant while specific amounts may vary.

In at least one embodiment, the solute 130 comprises, by weight: 480 g of citric acid, 240 g of sodium citrate, 240 g of sea salt, 33 g of ascorbic acid, and 7 g of calcium carbonate. It should be understood that the ratios of the compounds may remain constant while specific amounts may vary.

In at least one embodiment, the solute 130 comprises, by weight: 480 g of citric acid, 240 g of sodium citrate, 240 g of sea salt, 26 g of ascorbic acid, and 14 g of calcium carbonate. It should be understood that the ratios of the compounds may remain constant while specific amounts may vary.

In at least one embodiment, the solute 130 comprises, by weight: 2.4 g of citric acid, 1.2 g of sodium citrate, 1.2 g of sea salt, 1.2 g of lauryl glucoside, 0.090 g of ascorbic acid, 0.035 g of calcium carbonate, and 0.075 g of vegetable glycerin. It should be understood that the ratios of the compounds may remain constant while specific amounts may vary.

In at least one embodiment, the solute 130 comprises, by weight: 2.4 g of citric acid, 1.2 g of sodium citrate, 1.2 g of sea salt, 0.165 g of ascorbic acid, and 0.035 g of calcium carbonate. It should be understood that the ratios of the compounds may remain constant while specific amounts may vary.

In at least one embodiment, the solvent 140 is preferably water or other liquid. The solvent 140 may also be the natural moisture of food substances.

In at least one embodiment, the solute 130 is generated by blending the plurality of compounds according to their specific gravities and granular size. In some embodiments, the order of blending may be citric acid, sea salt, sodium lauryl sulfate, lauryl glucoside, sodium percarbonate, sodium citrate and vegetable glycerin. In some embodiments, a centrifugal blender may be used to generate the solute 130 from the compounds. Each compound may be added in sequence and blended until the solute is of a uniform composition. The blending in of a subsequent compound may last between 5 and 180 minutes in some embodiments.

In at least one embodiment, the solute can be a tablet that may be formed using known tablet making processes.

In some embodiments, the solute 130 may be added to the solvent 140 to form the solution 120. In this manner, the solute 130 may be transported inexpensively and conveniently in solid form as opposed to liquid form. Thus, the solution 120 may be generated with minimal effort.

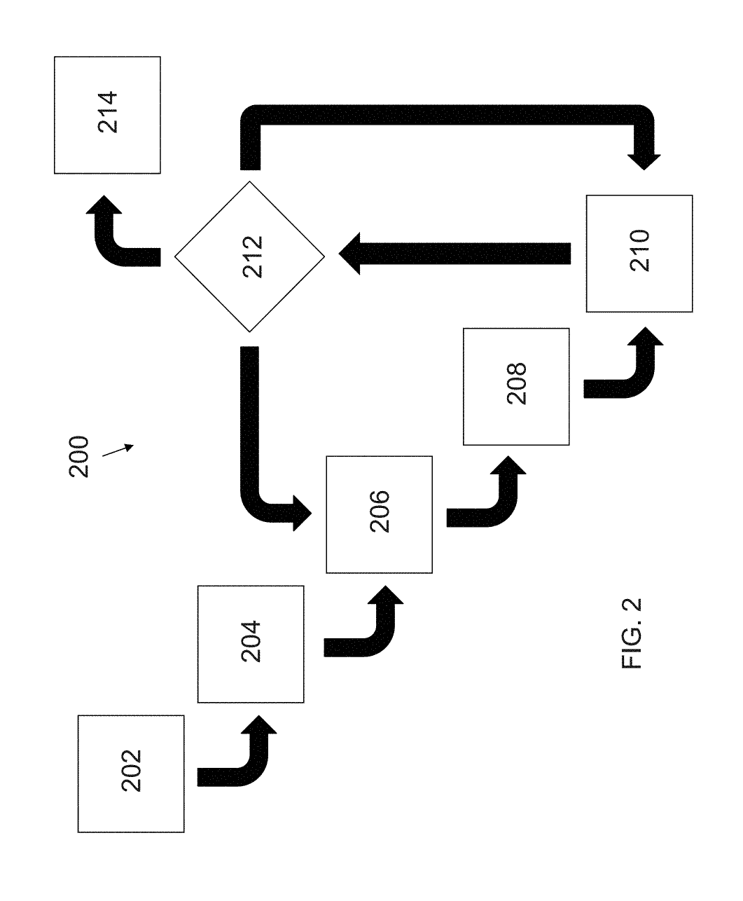

FIG. 2 shows an example embodiment flowchart diagram 200 detailing steps for cleaning using a preparation of formula. In some embodiments, a single scoop of powder or single serving of cleaning agent may be added to water to create a large quantity of cleaning solution. This cleaning agent can be concentrated or highly concentrated in various embodiments and may be stored in packets, tubs, boxes, or other packaging in various embodiments. As described herein, this cleaning agent when not in powder form can be a tablet, stick, or other solid form.

As shown in the example embodiment, a first step 202 can be to open a packet or otherwise prepare a serving of cleaning agent and then dispense it into water, for example one gallon of cold water. A second step 204 can be to thoroughly mix the cleaning agent and water until partially dissolved or fully dissolved. A third step 206 can be to soak food or other items in the combined cleaning agent and water solution for a period of time, for example for 30 seconds or another appropriate amount of time. A fourth step 208 can be to remove the soaked items or food. A fifth step 210 can be to rinse off the items or food with clean water. A sixth step 212 can be to check the items or food for cleanliness or any remaining solution, dirt, or other contamination. If necessary, steps 206 or 210 can be repeated at this step. Next, in step 214, the item or food can be dried and used or stored, as appropriate.

For example, in some embodiments, about two ounces of powder may be added to about ten gallons of water to create a large quantity of solution. In such embodiments, the scoop of powder can clean food or other items having one or more dirty surfaces by soaking the food or item in the solution for a period of time, for example about 15 to 30 seconds. Then the food or other item can be removed, rinsed, and the process can be repeated as necessary. Once cleaned, the food or item may be refrigerated or stored as necessary before consumption or use.

In the manner described with respect to FIG. 2, an individual can clean various items that adults, children, and infants may purposefully or accidentally put into their mouth, including: food, food related items, and various other items. Some examples of foods that can be cleaned in this manner include fruit, vegetables, and others. Examples of food related items that may be cleaned include utensils, cutting boards, bottles, dishes, lunch boxes, and others. Examples of various other items that may be put into the mouth include toys, pacifiers, and others.

As such, in this manner, the solutions described herein can be applied to various surfaces. They are able to better wash away or otherwise remove otherwise harmful or foreign agents such as pesticides, wax, residues, dirt, soil, and other substances that may contain, harbor, or otherwise provide or allow bacteria and other harmful agents to grow or live. As such, in some embodiments, these solutions and cleaning methods and systems can be up to 99.9% more effective than water washes that do are not specific solutions described herein. Further, in some embodiments, they can extend the shelf life of produce and other foods up to five times longer, six times longer, or more than existing formulas, solutions, or compositions, plain water washes, or completely untreated foods or items.

As described previously, it should be understood that it is desirable that these solutions, compositions, or formulas are safe, odorless, tasteless, and combinations thereof. Further, in some embodiments, these formulas can be up to one-hundred percent organic, all natural, vegan, gluten-free, non-GMO (Genetically Modified Organism) and otherwise non-detrimental to user's dietary needs, restrictions, and health. Thus, for example, solutions of water and ingredients such as citric acid, sodium citrate, sea salt, plant-derived surfactant, ascorbic acid, and calcium carbonate produce no harm to individuals and are operable to clean surfaces to a high degree.

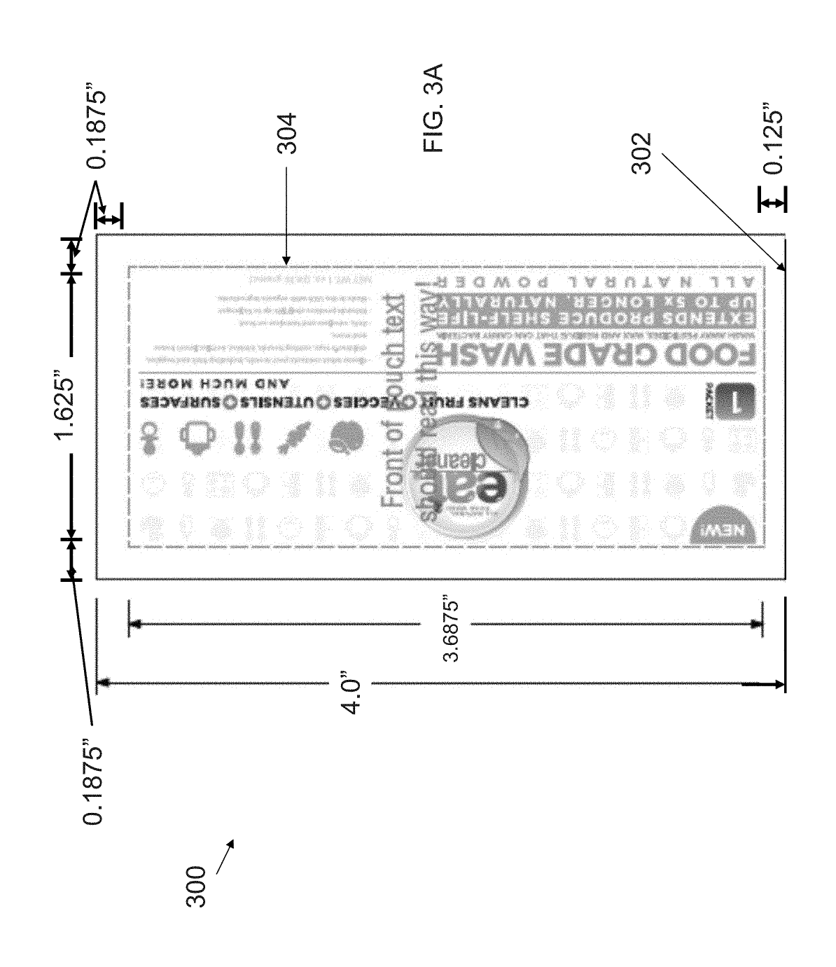

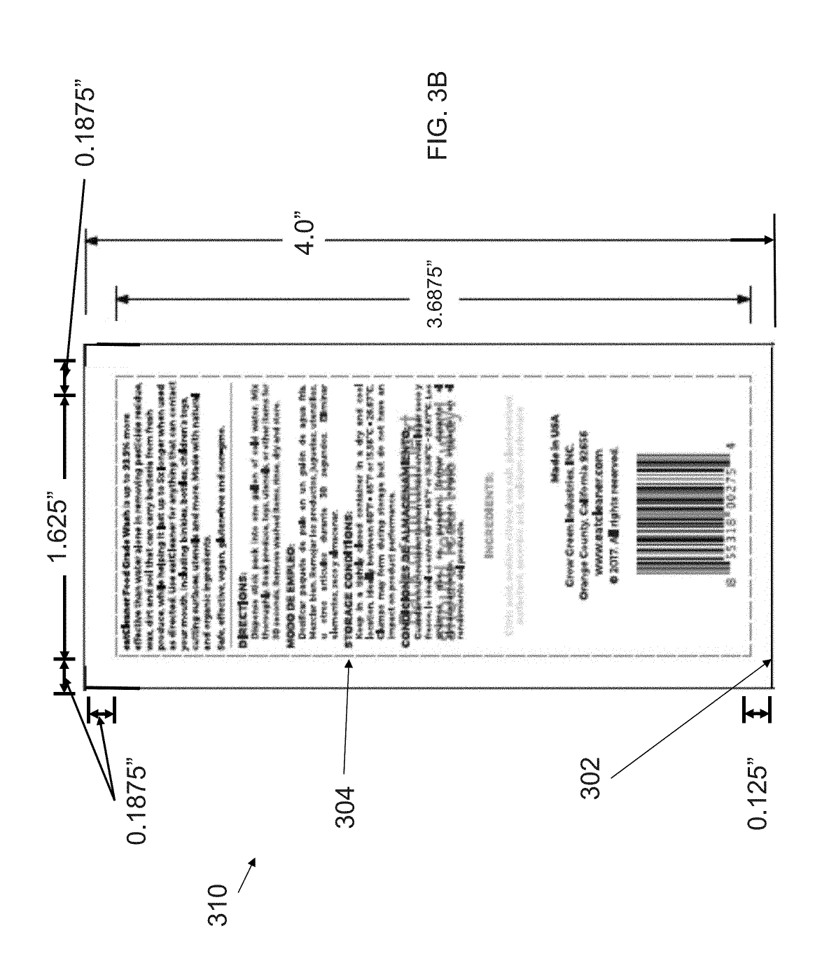

FIGS. 3A-3B show example embodiment diagrams 300 and 310 of a single-serving cleansing packet front and back for containing solid forms of formula for dilution and use in cleansing. As mentioned previously, in some embodiments, solutes can be stored in individual, single use packets. FIG. 3A shows a front side diagram 300 of a single-serving cleansing packet, while FIG. 3B shows a back side diagram 310 of a single serving packet. In some embodiments, these packets can be manufactured as a single sheet that is folded in half and has its sides and other end sealed to contain cleansing solutes within. For example, end 302 of FIG. 3A can be coupled or unified with end 312 of FIG. 3B.

As shown in the example embodiment, the length of the front and back of each packet can be about 4.0 inches and the width can be about 2.0 inches. A solvent holding area 304 that is shown by dashed lines in FIGS. 3A-3B can be about 3.6875 inches long by 1.625 inches wide. Edges around solvent holding area 304 can be about 0.1875 inches wide and run along the outer perimeter of both front and back sides of the packet, and be about 0.125 inches wide at the edges 302 and 312 where the sides are initially joined. Adhesives, glues, and other means of sealing the edges together can be used in various embodiments.

In the example embodiment, the single use packet can contain about one ounce or about 28.35 grams of formula. However, in some embodiments, can store larger or different amounts of formulas. In other embodiments, three ounce packets can be provided. For example, multiple use packets can contain more than one serving of formula. In various embodiments, multiple use packets can be resealable. These resealable packets are generally water and moisture proof and can be made or composed of various non-reactive plastics. They can be sealed or locked as known in the art or later developed.

In various embodiments of formulas described herein, solutes may require particular storage conditions. For example, when not in use, packets may need to be stored or kept n a tightly closed container in a dry and cool location. This may ideally be between about sixty degrees Fahrenheit and eighty-five degrees Fahrenheit, or 15.56 degrees Celsius to 26.67 degrees Celsius. In some embodiments, during storage, clumps of solute may naturally form due to temperature, moisture, pressure, reactions, or other conditions. However, clumping generally does not impact or otherwise affect performance and effects of solute use.

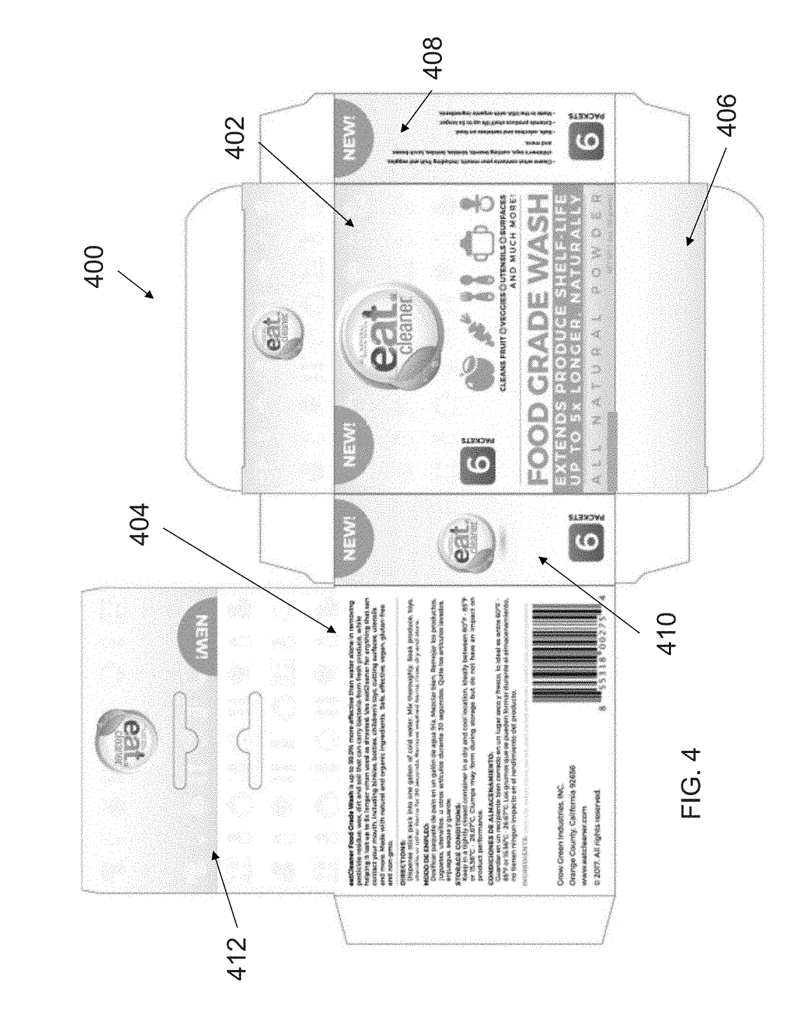

FIG. 4 shows an example embodiment packaging diagram 400 for a plurality of single-serving cleansing packets of formula. As shown, packaging can be a single sheet initially that includes a front side 402, back side 404, sides 408, 410, bottom 406, and front top 412 that is folded over to form a pitched upper structure when in use. Various flaps can be joined by adhesives or other means to create a closed final package.

Other embodiments of formulas can perform a variety of functions in various embodiments. For example, other embodiments of formulas, combinations of ingredients, or solvents can be anti-browning formulations for fruits and vegetables or other foods. These formulations can be inserted in pre-portioned packets which can be used by consumers at home to prevent or delay the browning of food items. In some embodiments, these formulations are can be used on organic produce as a processing aid.

In some embodiments, formula ranges for anti-browning formulations can include about: sixty to ninety percent ascorbic acid, about ten to twenty percent calcium carbonate, about five to fifteen percent citric acid, about one to ten percent sodium citrate, about 0.5 to five percent sea salt, and others.

In another embodiment, formulas have been found to particularly inhibit browning on cut or prepared apples, pears, avocado, potatoes, and other produce and vegetables that can experience dehydration. These formulas have also been found to prevent, inhibit, or substantially reduce the growth of yeast, mold, and coliform bacteria for much longer periods of time than untreated food, in some instances up to twenty-six days or longer. Further, these formulas have also been found to improve prepared foods. They can be mixed into food preparations during or after the preparation of the food itself. Examples of these types of food preparations include guacamole, hummus, soups, dressings, sauces, dips, prepared meals, deli salads, and other fresh and frozen foods. As such, these formulas can replace or supplement chemical or other natural preservatives when used.

In an example embodiment, a formula of about sixty-five to ninety percent ascorbic acid and about ten percent to thirty-five percent calcium carbonate can be used to inhibit browning and dehydration. It has been found that browning and dehydration of cut apples treated with these formulations can be reduced or prevented for up to twenty-six days or more. In another embodiment, a formula can include about sixty-five to ninety percent citric acid and about ten percent to thirty-five percent calcium carbonate

The enablements described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A system for reducing food borne illness comprising:
a solution consisting of a plurality of substantially organic compounds and water; and
an applicator for applying the solution to a surface of a food substance;
wherein the solution is substantially transparent.

2. The system of claim 1, wherein the compounds are selected from: citric acid, sodium citrate, vegetable glycerin, sea salt, potassium sorbate, decyl glucoside, Sodium Lauryl Sulfate, calcium ascorbate, grapefruit seed extract, sodium bisulfate, cocamidopropyl hydroxysultaine, and glycerin.

3. The system of claim 2, wherein the solution comprises approximately: 92.7% to 95.4% water, 2% citric acid, 2% sodium citrate, 0.2% vegetable glycerin, 0.2% potassium sorbate; 0% to 0.4% decyl glucoside, 0% to 0.2% calcium ascorbate, 0% to 0.2% grapefruit seed extract, 0% to 0.1% sodium bisulfate, and 0.2% to 2% sea salt.

4. The system of claim 1, wherein the solution consists of: 58.5% water, 20% citric acid, 10% sodium citrate, 10% cocamidopropyl hydroxysultaine, 1% glycerin, and 0.5% calcium ascorbate.

5. The system of claim 1, wherein a solute of the solution comprises: 290 g of citric acid, 290 g of sodium citrate, 290 g of sea salt, 60 g of decyl glucoside, 30 g of ascorbic acid, 25 of calcium carbonate and 15 g of vegetable glycerin

6. The system of claim 1, wherein a solute of the solution comprises: 480 g of citric acid, 240 g of sodium citrate, 240 g of lauryl glucoside, 22 g of ascorbic acid, 7 g of calcium carbonate, and 11 g of vegetable glycerin.

7. The system of claim 1, wherein the applicator comprises a spray bottle.

8. A system for reducing food borne illness comprising:
a solute consisting of a substantially homogeneous mixture of substantially organic compounds, the solute having the form of at least one of: a tablet and a powder;
a solvent for dissolving the solute therein to generate a solution; and
an applicator for applying the solution to a surface of a food substance;
wherein the solution substantially inhibits the growth of food borne illness causing organisms.

9. The system of claim 8, wherein the compounds are selected from: citric acid, sodium citrate, vegetable glycerin, sea salt, potassium sorbate, decyl glucoside, lauryl glucoside, Sodium Lauryl Sulfate, calcium ascorbate, grapefruit seed extract, sodium bisulfate, quillaja saponin, ascorbic acid, calcium carbonate, and sodium percarbonate.

10. The system of claim 8, wherein the solute comprises, by weight: 2.4 g of citric acid, 1.2 g of sodium citrate, 1.2 g of sea salt, .9 g of sodium lauryl sulfate, 0.090 g of ascorbic acid and 0.035 g of calcium carbonate.

11. The system of claim 8, wherein the solute comprises, by weight: 2.4 g of citric acid, 1.2 g of sodium citrate, 1.2 g of lauryl glucoside, 0.090 g of ascorbic acid, 0.035 g of calcium carbonate, and 0.075 g of vegetable glycerin.

12. The system of claim 8, wherein the solute comprises, by weight: 1.2 g of citric acid, 1.2 g of sodium citrate, 1.2 g of sodium percarbonate, 1.2 g of sodium lauryl sulfate, 0.090 g of ascorbic acid, 0.035 g of calcium carbonate, and 0.075 g of vegetable glycerin.

13. The system of claim 8, wherein the solute comprises, by weight: 480 g of citric acid, 240 g of sodium citrate, 240 g of sea salt, 15 g of sodium lauryl sulfate, 18 g of ascorbic acid, 7 g of calcium carbonate.

14. The system of claim 8, wherein the solute comprises, by weight: 480 g of citric acid, 240 g of sodium citrate, 240 g of sodium percarbonate, 18 g of ascorbic acid, 7 g of calcium carbonate, and 15 g of vegetable glycerin.

15. The system of claim 8, wherein the solute comprises, by weight: 480 g of citric acid, 240 g of sodium citrate, 240 g of sea salt, 18 g of ascorbic acid, 7 g of calcium carbonate, and 15 g of vegetable glycerin.

16. The system of claim 8, wherein the solute comprises, by weight: 480 g of citric acid, 480 g of sodium citrate, 33 g of ascorbic acid, and 7 g of calcium carbonate.

17. The system of claim 8, wherein the solute comprises, by weight: 480 g of citric acid, 240 g of sodium citrate, 240 g of sea salt, 26 g of ascorbic acid, and 14 g of calcium carbonate.

18. The system of claim 8, wherein the solute comprises, by weight: 2.4 g of citric acid, 1.2 g of sodium citrate, 1.2 g of sea salt, 1.2 g of sodium lauryl sulfate, 0.090 g of ascorbic acid, 0.035 g of calcium carbonate, and 0.075 g of vegetable glycerin.

19. The system of claim 8, wherein the solute comprises: 480 g of citric acid, 240 g of sodium citrate, 240 g of sea salt, 22 g of sodium lauryl sulfate, 11 g of ascorbic acid and 7 g of calcium carbonate

20. The system of claim 8, wherein the solute comprises: 480 g of citric acid, 240 g of sodium citrate, 240 g of sea salt, 22 g of lauryl glucoside, 18 g of ascorbic acid, 7 g of calcium carbonate
